(19) United States
(12) Patent Application Publication
(10) Pub. No.: US 2008/0211322 A1
(43) Pub. Date: Sep. 4, 2008

(54) Multipolar, Linear or Rotating Synchronous Direct Drive Motor

(76) Inventors: Wolfgang Heinrich, Hinternah (DE); Guido Zitzmann, Kuhndorf (DE)

Correspondence Address: BODNER & O'ROURKE, LLP, 425 BROADHOLLOW ROAD, SUITE 108, MELVILLE, NY, 11747, US

(21) Appl. No.: 11/660,609

(22) PCT Filed: Nov. 3, 2004
(86) PCT No.: PCT/EP04/12434

§ 371 Date: Oct. 2, 2007

(30) Foreign Application Priority Data
Sep. 3, 2004 (DE) 10 2004 042 768.2

(51) Int. Cl. H02K 21/12; H02K 41/03; H02K 21/24

(52) U.S. Cl. 310/12; 310/195; 310/214; 310/156.38

(57) ABSTRACT

The invention relates to a multipolar, linear or rotating synchronous direct drive motor which comprises a primary part and a secondary part. The primary part comprises a yoke and a plurality of teeth and slots interposed between said teeth, and winding strands of a polyphase winding running inside the slots. Between two winding strands of the same phase order the winding strands of the other phase or phases are disposed so as to overlap them. The secondary part is arranged opposite the primary part and comprises a plurality of permanent magnets of changing polarities on a common reflux base. The slot exits have an even slot pitch T<SB>N</SB> and the permanent magnetic poles have an even pole pitch T<SB>P</SB>. According to the invention, the winding strand of a respective phase winding consists of a continuous highly flexible braided wire, said braided wire being guided through the slots so as to meander around a group of teeth. The entire winding of a respective phase is configured by the braided wire which is arranged in layers in the respective slots. Every slot has a width that corresponds to the diameter of the insulated braided wire. The braided wires of the winding strands of the remaining phase or phases are guided between the slots of the first phase in a symmetrically off-set relation thereto. The layer structure of the winding of the meshed meandering winding strands results in flat winding overhangs having a small volume in the area of the points of intersection of the partial windings outside the slots.

The invention relates to a multipolar, linear, or rotating synchronous direct drive motor with a rotor, comprising a primary part with a yoke and a plurality of teeth as well as slots interposed between said teeth, winding strands of a polyphase winding extending between the slots, wherein between two winding strands of the same phase correlation the winding strands of the other phase or phases are disposed in an overlapping manner each, a secondary part which is arranged opposite the primary part and which comprises a plurality of permanent magnets of changing polarity on a common reflux base, in accordance with the preamble clause of Claim 1.

Known electrical machines comprise two-layer or two-level windings with winding schemes of a complicated structure. Due to the fact, that the coils of these intermeshed part-windings cross one another in the winding head because of this construction and have to be routed past one another, correspondingly large and bulky winding overhangs result with high copper losses.

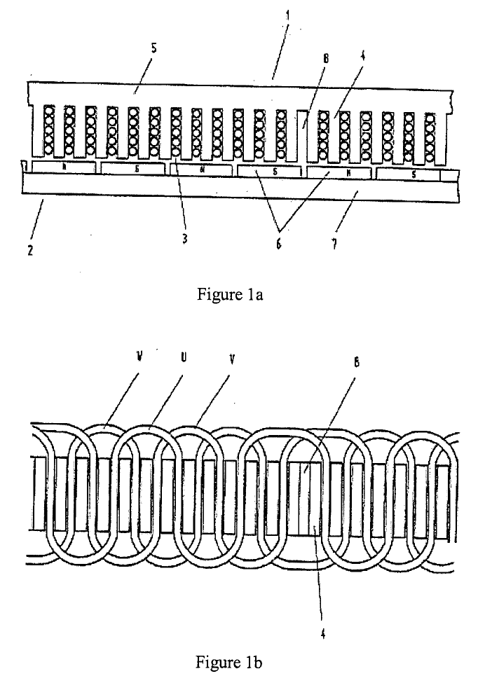

A typical lap winding in a meshed configuration for a three-phase a.c. motor is known from e. g. from Bala, C.; Fetita, Al., Lefter, V.: Handbuch der Winkeltechnik elektrischer Maschinen, Verlag Technik Berlin, 1976, FIG. 1.5.11.

The known state of the art further includes so-called imbricated windings for three-phase a.c. generators, which allow to be controlled more easily. Reference is made e. g. to DE 30 08 212 A1 which discloses various typical imbricated windings for three-phase a.c. generators.

In the overlap area of the part-windings of imbricated windings each of which is wound about a tooth group of a certain number of teeth, thickened areas occur which as a whole increase the installation space in an undesirable manner. With very long winding laps which extend over many slots, the relation between the active winding portions within the slots to the passive portion outside the slots shifts to the disadvantage of the motor efficiency.

Principally, any winding portion disposed outside the slots merely increases the winding resistance and thus the loss proportion with the consequence of a reduced motor efficiency.

With all meshed windings where the winding strands of the individual phases are disposed in a mutually overlapping relation in the slots of the primary parts and wound therein, there is the drawback that bulky winding overhangs are generated with a smaller efficiency compared to motors with so-called individual tooth windings, with the latter being able to be combined to pole groups with a certain phase shift.

An example of such individual tooth windings which are combined to pole groups with a certain phase shift is shown in DE 195 03 610 C2.

In such a poly-phase, multipolar, electrically commutatable machine, phase are provided zone-wise which are distributed along the stator, with one zone corresponding to one phase and the winding conductor of the phase within the zone being wound in alternating directions about stator poles which follow immediately one after the other.

The slot width between two neighbouring stator poles corresponds to the width of the winding conductor, with portions of the winding conductor, which come together within one pole slot being arranged above one another. A decisive disadvantage of a pole group motor which is designed in this manner is the considerable noise development. The reason for this is high fluctuations of the attractive force, which are distributed over a pole group, between the primary and the secondary part during the relative motion. Such partial force fluctuations cause small vibrations accompanying the pole frequency with the resulting noise, which depend on the rigidity of the bearing system. Therefore, the employment of pole group motors is not possible for certain applications where a low noise formation is of the essence.

In the poly-phase winding of an electrical machine according to the teaching of DE 198 46 923 C1 the object is to design this winding in such a manner that the motor created thereby is compact and capable of being subjected to high loads. To this end, a direct winding of the teeth is carried out by using a continuous braided wire, so that a strand winding with continuously wound coils is generated. This motor, too, suffers from the above described drawbacks with respect to the development of vibrations and noise.

In the method for manufacturing a shaft winding according to DE 101 58 267 A1 a plurality of parallel-wound and connected wires is prefabricated and pulled into the slots of the motor.

A parallel connection of part-windings, however, is disadvantageous in that even minute differences in amplitude and phase position of the counter voltages generated in the part-windings lead to undesired compensation currents and, above a certain speed, to heating and damping effects which are no longer controllable.

For very high-speed and simultaneously multipolar motors, the realisation of very low-resistance windings with a large winding cross section is to be attempted because of the counter voltage problems known from the state of the art. A further increase of the winding cross section in conventional motor constructions with varnished wire windings in the slots, which should be striven for, is either limited because of the wire cross sections which can be handled, or with the usual meshed winding types, associated with considerable wiring expenditures outside the slots and thus higher costs.

With respect to the mentioned counter voltage problem, it should be noted that synchronous motors develop an increasing counter voltage with an increase relative speed between stator or primary part, respectively, and rotor or secondary part, respectively. If the counter voltage reaches the range of the operating voltage, i. e. of the intermediate circuit voltage in the case of converters, the current flow in the motor will be limited, and a further speed increase of the motor will no longer be possible. If a motor, in particular, has to generate a high force or a high torque, respectively, and a high velocity, i. e. a high speed, at the same time, the voltage constant kᵥ (k_{ω}) is very high because of the necessary great number of poles, and the respective motor requires a very high operating voltage in order to achieve high speeds. Motors with a high force or torque yield are generally designed with high pole numbers, so that the object is basically given to eliminate the problem of increasing counter voltages.

With conventional wire windings with high winding cross sections, moreover, current displacement in the printed conductors occurs at higher control frequencies due to eddy current effects. This so-called SKIN effect results in undesired heat losses during the operation of the respective motors.

In other known motors, the focus is on certain ratios between slot number and the number of magnetic pole pairs. The slot number may, for example, correspond to 6 times the number of magnetic pole pairs, with the motor then being provided with a three-phase meshed winding due to the pole structure. Because of the high repetition rate in the constellation between slot and pole structure, reluctance effects will occur which interfere with the synchronous operation.

As proved this effect is the strongest when the slot number is an integer multiple of the pole number. Each slot with a defined width generates an elementary reluctance force upon the displacement of the motor relative to the opposite magnetic poles. In total, the elementary reluctance forces superpose to form an externally measurable total effect.

In the superposition of individual locking forces it is of importance whether these are acting in the same direction or in opposite directions or how the phase position relative to a magnetic period is, respectively.

In order to keep reluctance ripples small, the width of the slot outlet is normally minimised. It is also known to arrange the magnetic poles obliquely or to provide for an oblique lamination of the primary part, which, however, entails the side effect of a reduced power yield or a lower torque, respectively, of the motor.

In summary, pole group motors are known from the above referenced state of art, which also include embodiments, where the winding conductor is wound about successive stator poles within a zone with alternating direction. Due to their conventional winding configurations, such pole group motors have only a limited suitability for high speed applications. During the operation of such motors, internal reluctance force fluctuations and vibration effects result in an undesired noise.

Based on the above it is therefore the object of the invention to specify an advanced multipolar, linear, or rotating synchronous direct drive motor which comprises a winding which meets the extreme requirements with respect to synchronous operation properties, high relative speeds, low noise, compactness, and simple manufacturing.

The inventive motor with a large number of poles is intended to have an efficient and simultaneously low-resistance winding so that an application is possible where relative speeds in the air gap of approx. 10 m/sec up to 50 m/sec and above occur, and where a special synchronous operation with minimum noise generation is required. While meeting the above mentioned requirements, the motor should be suitable also for applications in the field of medical engineering, but also in the field of mechanical engineering, as a drive for high-speed spindles or rotary tables for machining, in particular grinding operations.

The object of the invention is solved with a multipolar, linear, or rotating synchronous direct drive motor according to the combination of characteristics of Claim 1, with the dependent claims representing at least useful embodiments and advancements.

To this end and according to the invention, one polyphase meshed winding per motor phase with an essentially continuous winding conductor is routed meander-like through the respective slots of the primary part, with the winding having a multilayer configuration.

This preferred meander-like routing of the winding conductor ensures short, compact winding overhangs and thus low winding resistance values as well as a high efficiency of the motor.

Due to the above continuous configuration principle of the winding conductors, a series connection of the slot windings is obtained with advantages concerning the counter voltage problem which has not been satisfactorily solved in the state of the art.

With the preferred employment of an insulated braided copper wire as an essentially continuous winding conductor, which with a correspondingly large cross section is able to carry a high current load and which with a small number of windings induces only low counter voltages, it is possible to design the motor for extremely high velocities or speeds, respectively.

The use of an electrically insulated braided wire at a high-frequency control additionally minimises the SKIN effect so that compared to a winding with thick copper wire, further advantages result.

Compared to conventional wire windings, a braided wire winding is also much more flexible and technologically simpler to install, so that only with a high copper cross section proportion in the conductor a more continuous series connection generally becomes possible.

An advantage of the series connection which can be realised according to the invention as opposed to a multiwire, looped, and parallel-connected copper wire winding is its unique suitability for the highest relative speeds. Because of impedance differences and magnetising differences there are always undesired compensation currents in parallel branches, which with higher speeds increase considerably and lead to an undesired heating.

The special layered construction of the intermeshed, very shallow meander windings leads to only very small thickened overhang areas in the region of the intersection points of the part-windings and to a very intimate contact of the individual layers so that a very compact motor may be produced.

In a preferred embodiment, the slots of the inventive motor are essentially made as wide as the braided wire including the existing or necessary, respectively, insulation layer of the conductor.

Because of this measure, the individual meander-like layers of the braided wires are located immediately one above the other and are clamped within the slot between the teeth where they are frictionally secured. This constructive measure facilitates the manufacturing process when making the winding, which may be done either manually but also automatically.

In an embodiment of the invention, a braided wire is used with a large conductor cross section ranging from 2.5 to 6 mm² with an outer diameter of up to approx. 5 mm. Within this range, the ratio of copper cross section and outer insulation is very favourable and readily adaptable to slot widths which preferably are realised in the range from 3 to 5 mm.

In the case of the intended meshed winding, the above described winding construction allows for the first time the realisation of high pole numbers and thus an increase of the force and torque yield as well as the efficiency of the motor.

Due to the fact that relatively small slot pitches can be realised, the overall pole width which, in a three-phase motor spans three slots and in a two-phase motor spans two slots, can be kept relatively small.

In order to minimise an undesired slot locking, an advantageous ratio between slot number and pole pair number or the motor is selected.

In a three-phase motor, the slot number is higher than six times the pole pair number of the magnet arrangement. The meander winding is distributed in such a manner that over the entire motor at equally spaced intervals, one slot each remains unwound as a passive slot, with the number of the actively wound slots corresponding to six times the number of pole pairs.

In the meander-type winding operation of the primary part, the passive slots are skipped, and the winding scheme is continued.

A selection of the slot number with a difference higher than the necessary slot number results in a phase offset from slot to slot relative to the magnetic matrix and therefore to a nearly complete compensation of the reluctance forces and the undesired slot locking. These undesired effects are also able to be reduced because the slot intervals and thus the teeth may be formed very narrow.

In addition, the provision of the passive slots serves to compensate the phase position of the winding relative to the magnetic pole arrangement.

Principally, the inventive teaching may be employed with closed rotating or similar linear motors or arc segment motors. The relative forces and speeds which are applicable to a correspondingly defined motor element are convertible via the given radius.

With a rotating motor or a rotating motor segment, this may be constructed coaxially or flat like a disk armature. In the case of a flat arrangement, the axes of symmetry of the slots and of the magnetic poles are directed towards the respective centre of rotation, with the magnetic poles of one embodiment having wedge-shaped flanks.

In summary, the synchronous direct drive motor to be created comprises winding strands for the respective phase windings which consist of a continuous highly flexible braided wire, with the braided wire being routed meander-like about one tooth group each through the slots which may be designed narrow.

The entire winding of a respective phase is formed by braided wires which are layered above one another in the respective slots.

Each slot has a width which corresponds to the diameter of the insulated braided wire. The braided wires of the winding strands of the further phase or phases are systematically routed in an offset manner between the slots of the first phase, so that due to the layered winding construction of the meshed meander winding strands in the area of the intersection points of the part-windings outside the slots, only slightly bulky winding overhangs with the described advantages are generated.

In a preferred embodiment, the meander winding strands are distributed over the total length of the primary part that passive slots remain in uniform intervals.

The invention will be explained in more detail in the following with reference to an embodiment and with the aid of figures; in which:

FIG. 1a shows a portion of an inventive motor in with visually discernible winding strands;

FIG. 1b is a plan view of the motor according to the illustration of FIG. 1a;

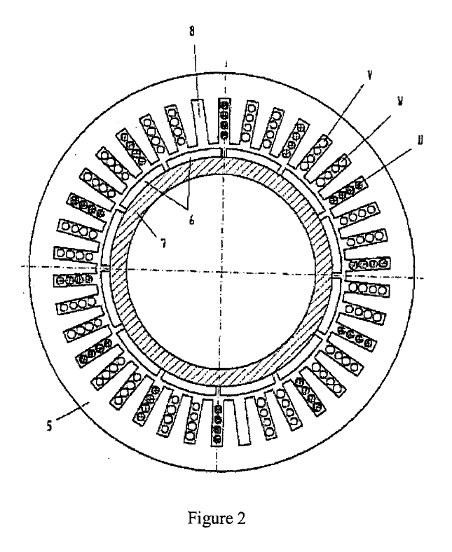

FIG. 2 shows an inventive three-phase rotating motor with 38 slots and 12 magnetic poles, with the meander winding being constructed of four layers;

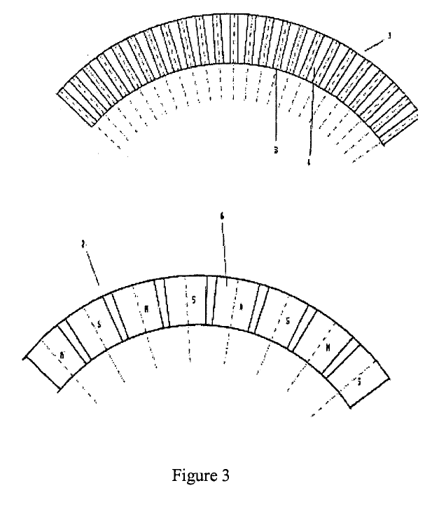

FIG. 3 shows an embodiment of the inventive motor as a disk armature or disk armature segment, respectively, as a plan view of the primary part 1 or the secondary part 2, respectively; and

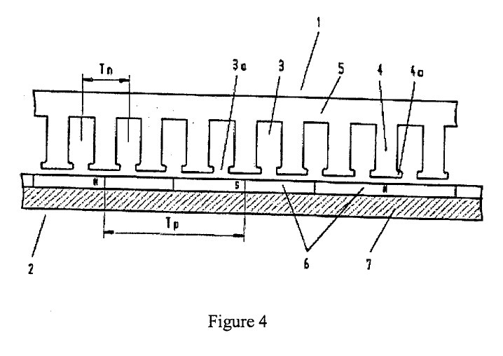

FIG. 4 is a principal illustration of a motor construction with a discernible slot pitch Tₙ and Tₚ, respectively.

In the illustrations according to FIGS. 1a and 1b, a primary part 1 with a yoke 5 is provided, with the primary part 1 having a plurality of equally spaced teeth 4 with slots 3 located between them.

The secondary part 2 which is arranged opposite the primary part 1 comprises a plurality of permanent magnets 6 which have a changing polarity and are arranged on a common reflux base 7.

According to the embodiment, the slots 3 are approximately as wide as the teeth 4 located between them which do not have defined tooth tips. In the shown example, the slots are formed essentially parallel.

A three-phase braided wire winding is routed meander-like within the slots (see also FIG. 1b). Within a motor phase U, the respective braided wire is routed in each fourth slot. In between, the braided wires of phases V and W are arranged in the slots in a sequence as required by the associated magnet arrangement.

For the embodiment of the invention it is of no importance whether the braided wires of all three phases are routed in the same sense of winding or not.

An advantageous embodiment of the invention is obtained, however, when the braided wire of phase W between phases U and V is routed in an opposite sense of winding. This results in a very uniform winding scheme as can be seen from FIG. 1b.

In the example according to FIGS. 1a and 1b, the meander winding is constructed in five layers.

The points of intersection are located between the individual braided wires and, from one layer to the other, are offset and interleaved in such a manner that the entire multilayered winding is intermeshed.

Within the motor twelve slots 3 each are wound which are then followed by a passive slot 8. Following the passive slot 8, the winding scheme is continued correspondingly.

Besides its high final speed of more than 47 m/sec, the inventive motor also has a particularly pronounced good synchronous operation and, compared to low pole number spindle drives, comprises a higher torque yield and thus an improved efficiency. Measures which are otherwise necessary, such as a chamfering of the magnetic poles or the slots within the core assembly, may be dispensed with.

With an exemplary segment motor with an arc length of 500 mm at a radius of 550 mm for the direct drive of a medical apparatus with speeds up to 250 rpm it could surprisingly be demonstrated that the realised inventive arrangement causes considerably lower noise emissions than a pole group motor of the same size with a coarser slot pitch. The direct comparison at otherwise corresponding conditions resulted in a noise reduction of the inventive motor from 75 dB to 62 dB.

FIG. 2 shows an inventively realised three-phase rotating motor with 38 slots and 12 magnetic poles. With this embodiment, the meander winding is constructed of four layers.

36 slots of the 38 slots shown therein are wound so that two passive slots remain. The distance between the passive slots corresponds to 18 slots.

With an air gap diameter of 90 mm and an air gap length of 100 mm, the exemplary motor produces a speed of more than 10,000 rpm at a continuous torque of approx. 10 Nm.

The cycle of the reluctance ripple is obtained as T_{R}=3600/19×6=3.15°. This means that 114 reluctance ripples are generated per one revolution of the motor, which due to their phase offset compensate each other nearly completely.

Besides its high final speed of more than 47 m/sec, the inventive motor also has a particularly pronounced good synchronous operation and, compared to low pole number spindle drives, comprises a higher torque yield and thus an improved efficiency. Measures which are otherwise necessary, such as a chamfering of the magnetic poles or the slots within the core assembly, may be dispensed with

The proposed winding brings about considerable technological advantages compared to conventional lap windings or wave windings, together with a much more compact motor construction.

FIG. 3 shows a possible embodiment of the inventive motor as a disk armature or disk armature segment, respectively, as a plan view of the primary part 1 or the secondary part 2, respectively.

The parallel slots 3 with their axes of symmetry are directed to the centre of rotation of the centre, respectively, of the motor.

The magnetic poles 6 with their axes of symmetry (chain-dotted lines) are also oriented towards the centre of rotation. With small radii, a selection of wedge-shaped or trapezoid, respectively, magnet geometries is advantageous.

The braided wire winding may be very well adapted here, and also to such non-parallel slot structures.

The presented inventive motor may also be employed for a generator operation, i. e. with a forced relative movement, for the generation of electrical energy. The described advantages will also become apparent in this case. With respect to application possibilities, e. g. wheel drives in commercial transport vehicles are conceivable, which in thrust or braking operations function as generators for the generation of energy and which supply this energy for storage in accumulators.

In summary, the inventive motor succeeds by means of the design of a polyphase meshed winding per motor phase with a continuous winding conductor which is routed meander-like through the slots of the primary part and which comprises a multilayered construction, to achieve the desired high synchronous operation with high relative speeds and low noise emission, with the motor itself being compact and easy to manufacture.

1. A multipolar, linear, or rotating synchronous direct drive motor,
comprising
a primary part with a yoke and a plurality of teeth as well as slots interposed between said teeth,
winding strands of a polyphase winding extending in the slots, wherein between two winding strands of the same phase correlation the winding strands of the other phase or phases are disposed in an overlapping manner each,
a secondary part which is arranged opposite the primary part and which comprises a plurality of permanent magnets of changing polarity on a common reflux base,
with the slot outlets having a uniform slot pitch Tn and the permanent magnets having a uniform pole pitch Tp,
characterised in that
the winding strand of a respective phase winding consists of a continuous flexible braided wire, with the braided wire being routed meander-like about a tooth group through the slots, with the entire winding of a respective phase being formed by the braided wires which are layered one above the other in the respective slots,
each slot has a width which corresponds to the diameter of the insulated braided wire and the braided wires of the winding strands of the other phase or phases are symmetrically routed between the slots of the first phase in an offset manner, so that the layered winding construction of the meshed meander winding strands results in flat, slightly bulky winding overhangs in the area of the points of intersection of the part-windings outside the slots.

2. The motor according to claim 1,
characterised in that
the meander winding strands are distributed over the total length of the primary part in such a manner that passive slots remain.

3. The motor according to claim 1,
characterised in that
the braided wires are held clamped in the slots, by which they are secured.

4. The motor according to claim 1,
characterised in that
the braided wires have a wire cross section of essentially 2.5 to 6.0 mm² at an outer diameter of up to 5 mm.

5. The motor according to claim 1
characterised in that
in a three-phase motor the number of slots is higher than 6 times the number of pole pairs of the magnet arrangement, with the number of the actively wound slots corresponding to six times the pole pair number, the meander winding being distributed in such a manner that over the entire motor one slot each remains unwound in equally spaced intervals, and the winding scheme is maintained beyond the passive slot.

6. The motor according to claim 1,
characterised in that
in a two-phase motor the number of slots is higher than 4 times the number of pole pairs of the magnet arrangement, with the number of the actively wound slots corresponding to four times the pole pair number, the meander winding being distributed in such a manner that over the entire motor one slot each remains unwound in equally spaced intervals, and the winding scheme is maintained beyond the passive slot.

7. The motor according to claim 1
characterised in that
each slot comprises essentially parallel flanks over its entire depth and the teeth do not have a typical tooth tip formation.

8. The motor according to claim 1,
characterised in that
the slot pitch is selected smaller than 8 mm and the magnet pitch is selected smaller than 25 mm.

9. The motor according to claim 1
characterised in that
the continuous braided wire is a copper stranded hook-up wire surrounded by a high-temperature resistant insulation material, comprising a plurality of individual wires.

10. The motor according to claim 1
characterised in that
the motor is used for the direct drive of an X-ray tube.

11. The motor according to claim 1,
characterised in that
the motor is used for the direct drive of CT scanner.

12. The motor according to claim 1
characterised in that
the motor is constructed rotating as a disk armature or a disk armature segment, with the slot centre axes being oriented radially towards the centre of rotation.

13. The motor according to claim 12,
characterised in that
the poles of the permanent magnets are formed trapezoid or wedge-shaped, with the smaller face each being oriented towards the centre of rotation of the motor.

14. The motor according to claim 2,
characterised in that
each 6th slot maximum and each 24th slot minimum is made an unwound passive slot.

15. The motor according to claim 2,
characterised in that
the passive slots are arranged in pregiven intervals.

16. The motor according to claim 15,
characterised in that
the pregiven intervals are derived from the magnet matrix of the machine.

17. The motor according to claim 15,
characterised in that
the passive slots are arranged in uniform intervals.

18. The motor according to claim 1,
characterised in that
it comprises a multilayer winding or a single-layer winding.

19. The motor according to claim 2,
characterised in that
the braided wires are held clamped in the slots, by which they are secured.

20. The motor according to claim 2,
characterised in that
the braided wires have a wire cross section of essentially 2.5 to 6.0 mm² at an outer diameter of up to 5 mm.
